(19) United States
(12) Patent Application Publication
(10) Pub. No.: US 2006/0059146 A1
(43) Pub. Date: Mar. 16, 2006

(54) Method and system for tracing components of computer applications

(75) Inventors: Cameron James McAllister, Chandlers Ford (GB); Philip Richard Taunton, Eastleigh (GB); Yuk Lun Wong, Romsey (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/942,410

(22) Filed: Sep. 16, 2004

(51) Int. Cl. G06F 17/30

(52) U.S. Cl. 707/6

(57) ABSTRACT

A method and a system for tracing components 202 in computer applications 203 are provided. A trace point has a unique identifier and a bit pattern. The level of filtering of trace points is carried out by providing filtering means 303, 402 using the bit pattern and including means for carrying out an inclusive test 403 to determine if a trace point is to be logged and means for carrying out an exclusive test 404 to determine if a trace point is not to be logged. The unique identifier references text commentary 701 relating to the trace point which is written into the original source code and catalogued at compilation for retrieval when a trace point is traced. The method and system allow a single trace system to trace data from both native and non-native applications.

### TECHNICAL FIELD

This invention relates to the field of tracing components of computer applications in a computer system. In particular, this invention relates to filtering the level of data to be traced and to providing associated text for trace points.

### BACKGROUND OF THE INVENTION

Software tools are used to monitor and analyse the execution of computer applications on a computer system. The form of monitoring may vary from receiving occasional event messages to recording every step or operation of an application for evaluation.

The term logging is generally used to refer to monitoring systems that provide real-time feedback for administrative control. Therefore, a logging system generates low quantity, high importance messages. Logging keeps a record of reported events stored on disk and should be reliable and translatable.

The term tracing is used to refer to a system which is not just a detailed logging system but provides a system for problem determination and system support. Tracing should keep a history of events. It should also be reliable in that it should never fail and it should never loose trace data that is meant to be stored. Details are provided to the developer or product support group. The points at which data is logged in a trace system are referred to as trace points.

Tracing generally works by placing trace entries at important places in an application, where decisions are made or a sequence of events occurs. These trace entries are method calls to the trace system, telling it where the flow of the application has reached and passing any data that would be useful to know. The trace system then records this to a file, which may then be analysed to tell what the application did when it was run. With this information, problems within the application may be identified and fixed.

Known tracing systems are generally accessed by only one type of application such as a native application which is designed for a particular type of microprocessor on which it is running, for example, a C++ language application, or a non-native application which uses an emulator application such as a Java application (Java is a trade mark of Sun Microsystems, Inc.) running on a Java Virtual Machine (JVM). Java applications also call native code when running as native code is much faster than Java code and therefore, any substantial work is carried out by native code.

There is a requirement for a high-performance tracing system that can be accessed from multiple processes running on both native and non-native applications with the ability to adjust the trace content as required. In addition, a clear textual description of a trace point is desirable in order for a trace point to be quickly and unambiguously identified.

It is an aim of the present invention to provide a trace system in which all components on a system being monitored are traced into a single trace system. Both native and non-native code are able to trace and log into the trace system. It is a further aim to provide dynamic control of the trace system.

Known trace tools use a filter mechanism to choose which trace point to trace depending on the category of trace point. Normally category types are described by names such as major, minor, data, entry, etc. and trace points can be filtered according to their name. However, when a large number of trace points are being handled, such name filtering can be cumbersome and slow and may not provide the control required.

It is proposed, in one aspect of the present invention, to use binary code to categorize trace points and enable the inclusion and exclusion of certain bit combinations. This is one of the simplest and fastest computer operations and reduces the resources needed compared to name filtering.

Known trace tools use a text string to describe a trace point in an application, a collection of trace strings form a catalogue and normally this catalogue is formed manually by the developer or tester of the application.

It is proposed, in another aspect of the present invention, that comment tags associated with the trace points in the source code of the test application are used to form a catalogue during compilation and prior to tracing the test application.

### SUMMARY OF THE INVENTION

According to a first aspect of the present invention there is provided a method for filtering components to be traced in computer applications comprising: providing a trace point in a computer application with a bit pattern; carrying out an inclusive test by comparing the bit pattern to an inclusive bit mask, accepting the bit pattern if a bit of the bit pattern matches the bit mask; carrying out an exclusive test by comparing the bit pattern to an exclusive bit mask, accepting the bit pattern if none of the bits of the bit pattern matches the bit mask; and tracing a trace point which is accepted by both the inclusive test and the exclusive test.

According to a second aspect of the present invention there is provided a method for tracing components in computer applications comprising: providing text commentary in source code associated with trace points; storing the text commentary in a catalogue at compilation of the source code; and retrieving the text commentary when a trace point is traced.

Each trace point may have a unique identifier and the text commentary may be referenced by the unique identifier. The method may include retrieving the text commentary during formatting of the trace point data.

According to a third aspect of the present invention there is provided a method for tracing components in computer applications comprising: providing each trace point with a unique identifier and a bit pattern; filtering the trace points to be traced by comparing the bit pattern to a filter mask; and formatting the data from the trace point including retrieving text commentary referenced by the unique identifier.

The filtering may include: carrying out an inclusive test by comparing the bit pattern to an inclusive bit mask, accepting the bit pattern if a bit of the bit pattern matches the bit mask; carrying out an exclusive test by comparing the bit pattern to an exclusive bit mask, accepting the bit pattern if none of the bits of the bit pattern matches the bit mask; and tracing a trace point which is accepted by both the inclusive test and the exclusive test.

According to a fourth aspect of the present invention there is provided a system for tracing components in computer applications comprising: a trace server for logging data from one or more applications; filtering means for filtering data to be logged from trace points in the applications including: means for carrying out an inclusive test to determine if a trace point is to be logged; and means for carrying out an exclusive test to determine if a trace point is not to be logged.

The inclusive and exclusive tests may set the trace level. Each trace point may have a bit pattern, and the means for carrying out the inclusive test may compare the bit pattern to an inclusive bit mask and accept the bit pattern if a bit of the bit pattern matches the bit mask, and the means for carrying out an exclusive test may compare the bit pattern to an exclusive bit mask and accept the bit pattern if none of the bits of the bit pattern matches the bit mask; the filtering means forwarding data to the trace server from trace points which are accepted by both the inclusive test and the exclusive test.

The system may include shared memory for storing binary formatted trace data; and storage means to which the trace data is written in blocks form the shared memory.

According to a fifth aspect of the present invention there is provided a system for tracing components in computer applications comprising: a formatter for formatting the trace data for a trace point; a catalogue storing the text commentary associated with a trace point; and the formatter including means for retrieving the text commentary for a trace point.

Each trace point may have a unique identifier and the catalogue may identify the text commentary by the unique identifier.

According to a sixth aspect of the present invention there is provided a system for tracing components in computer applications comprising: means for providing trace points with a unique identifier and a bit pattern; filtering means for filtering the trace points to be traced by comparing the bit pattern to a filter mask; formatting means for formatting the data from the trace point including retrieving text commentary referenced by the unique identifier.

The filtering means may compare the bit pattern to an inclusive mask and an exclusive mask to set the trace level. The filtering means may include means for carrying out an inclusive test comparing the bit pattern to an inclusive bit mask and accepting the bit pattern if a bit of the bit pattern matches the bit mask, and means for carrying out an exclusive test comparing the bit pattern to an exclusive bit mask and accepting the bit pattern if none of the bits of the bit pattern matches the bit mask; the filtering means forwards data to a trace server from trace points which are accepted by both the inclusive test and the exclusive test.

According to a seventh aspect of the present invention there is provided a computer program product stored on a computer readable storage medium, comprising computer readable program code means for performing the steps of: providing a trace point in a computer application with a bit pattern; carrying out an inclusive test by comparing the bit pattern to an inclusive bit mask, accepting the bit pattern if a bit of the bit pattern matches the bit mask; carrying out an exclusive test by comparing the bit pattern to an exclusive bit mask, accepting the bit pattern if none of the bits of the bit pattern matches the bit mask; and tracing a trace point which is accepted by both the inclusive test and the exclusive test.

According to an eighth aspect of the present invention there is provided a computer program product stored on a computer readable storage medium, comprising computer readable program code means for performing the steps of: providing text commentary in source code associated with trace points; storing the text commentary in a catalogue at compilation of the source code; and retrieving the text commentary when a trace point is traced.

According to a ninth aspect of the present invention there is provided a computer program product stored on a computer readable storage medium, comprising computer readable program code means for performing the steps of: providing text commentary in source code associated with trace points; storing the text commentary in a catalogue at compilation of the source code; and retrieving the text commentary when a trace point is traced.

In all the aspects of the present invention, the bit pattern for a trace point may represent a category of the trace point or a component in the computer application. The inclusive and the exclusive bit masks determine the level of tracing. In this way, the level of tracing can be altered to include or exclude particular categories or components.

The trace points may be provided in native and non-native applications.

Embodiments of the present invention will now be described, by way of examples only, with reference to the accompanying drawings.

### BRIEF DESCRIPTION OF THE DRAWINGS

FIG. 1 is a block diagram of a computer system on which the present invention may be implemented;

FIG. 2 is a block diagram of a trace system in accordance with the present invention;

FIG. 3 is a block diagram of a trace system in accordance with the present invention;

FIG. 4 is a block diagram of the wrapper application of the trace system in accordance with the present invention;

FIG. 5 is a schematic diagram of the inclusive and exclusive mask checks in accordance with an aspect of the present invention;

FIGS. 6A and 6B show examples of the inclusive and exclusive mask checks in accordance with an aspect of the present invention; and

FIG. 7 is a schematic diagram of a file formatter in accordance with an aspect of the present invention.

### DETAILED DESCRIPTION

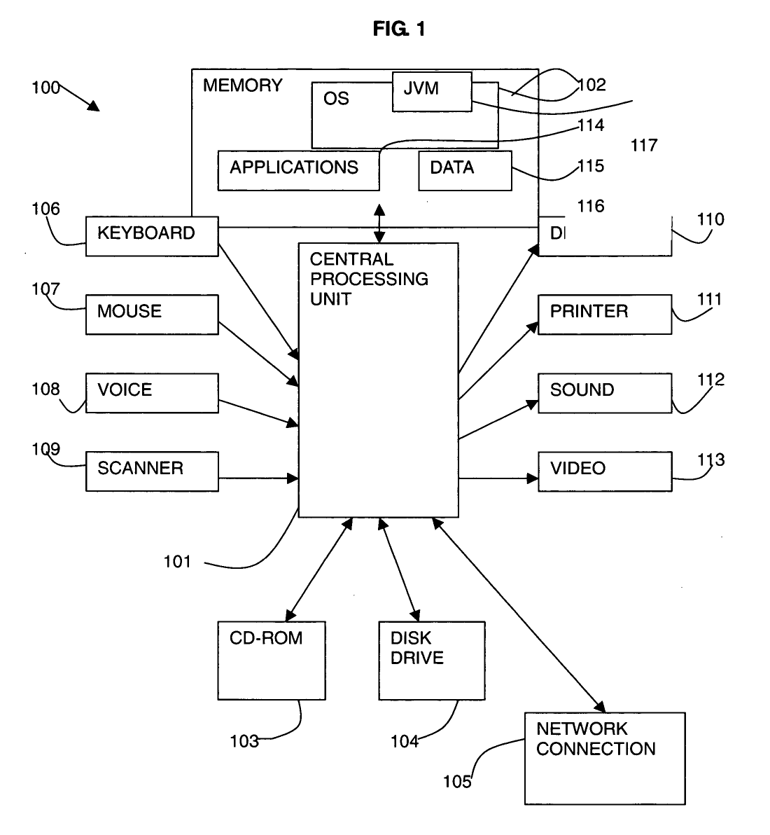

Referring to FIG. 1, a computer system 100 is shown as an example of a system on which the present invention may be implemented. A computer system 100 has a central processing unit 101 with primary storage in the form of memory 102 (RAM and ROM). The memory 102 stores program information 114, 115 and data 116 acted on or created by the programs. The program information includes the operating system code for the operating system 114 of the computer system 100 and application code for applications 115 running on the computer system 100. Secondary storage includes optical disk storage 103 and magnetic disk storage 104. Data and program information can also be stored and accessed from the secondary storage.

The computer system 100 includes a network connection means 105 for interfacing the computer system 100 to a network such as a local area network (LAN) or the Internet. The computer system 100 may also have other external source communication means such as a fax modem or telephone connection.

The central processing unit 101 includes inputs in the form of, as examples, a keyboard 106, a mouse 107, voice input 108, and a scanner 109 for inputting text, images, graphics or the like. Outputs from the central processing unit 100 may include a display means 110, a printer 111, sound output 112, video output 113, etc.

In a distributed system, a computer system 100 as shown in FIG. 1 may be connected via a network connection 105 to a server on which applications may be run remotely from the central processing unit 101 which is then referred to as a client system.

A Java virtual machine (JVM) 117 can be provided supported by the operating system 114 of the computer system 100. A JVM 117 is a computer program that simulates the operation of components in a computer system.

One or more computer systems 100 may be monitored in order to evaluate the performance of components within the system or systems 100. A trace system may be in the form of a tool which monitors the performance of components in a computer system such as that shown in FIG. 1. The trace system may be local to the computer system 100 or may operate via a network connection, for example from a server monitoring one or more client computer systems. The components may be software components which send messages to the trace system.

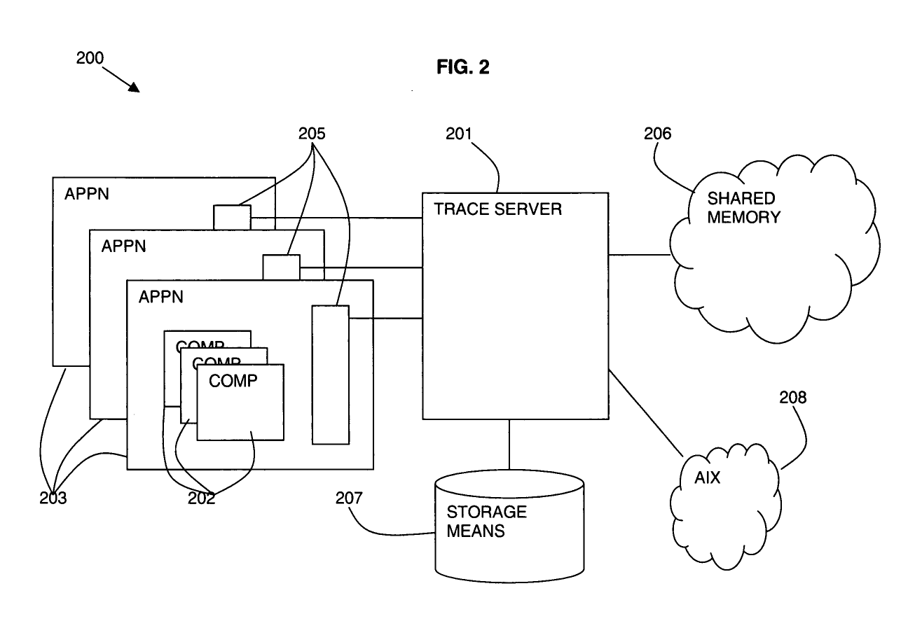

FIG. 2 shows an embodiment of a trace system 200 in which a trace server 201 is provided which logs data provided from components 202 of one or more applications 203 running on one or more client computer systems. In one embodiment, the trace server 201 runs on the same computer system as the applications 203 which are being traced. The applications 203 are linked to the trace server 201 via library calls which write to a shared memory 206.

In an alternative embodiment, the trace system 201 may be provided via a communications network using a network protocol to communicate. However, this form of system has the disadvantage of providing a slower form of trace.

The trace server 201 communicates with application trace layers 205 which represent their applications 203. Each application trace layer 205 of an application 203 may run on a Java virtual machine. Alternatively, the application trace layer 205 may be provided on the platform of the client computer system. Components of applications 202 from which data is provided to the trace server 201 via the client trace layer 205 may be in either native code or non-native code such as Java code.

The trace server 201 also includes a process that looks after the shared memory 206, and when it is too big, writes it to a storage means 207.

The trace server 201 enables all components in a plurality of applications on a computer system or on distributed computer systems to be traced in a single trace system 200. As described further below, the trace system 200 provides dynamic control over the trace of components.

The trace server 201 is started automatically when one of the application trace layers 205 is started. The trace server 201 controls the overall trace mode of the trace system 200.

The trace server 201 has shared memory 206 and is also connected to storage means 207 such as hard disk storage. There may also be provided an AIX (Advanced Interactive Executive) system trace 208 (AIX is a registered trademark of International Business Machines Corporation). The trace server 201 manages the shared memory 206 and synchronisation objects. The shared memory 206 is used to store binary formatted trace data in memory for high performance throughput. The shared memory is a circular buffer and the trace data is written to the storage means 207 periodically.

The trace server 201 controls the usage of the storage means 207 for trace data and enables the trace system 200 to write to the storage means 207 in large blocks. The writing of trace data to the storage means 207 (referred to as writing to disk) may use one of several possible modes. The following are examples of modes; however, other modes may also be used:
a) store all trace data in memory until an error condition occurs, then write the memory buffer to disk;
b) as a), but automatically moves to mode c) when the error occurs;
c) write to disk when a certain amount of trace data has be accumulated in memory (for example, 10 kbytes default);
d) redirect trace to the AIX system trace for combined operating system and product trace.

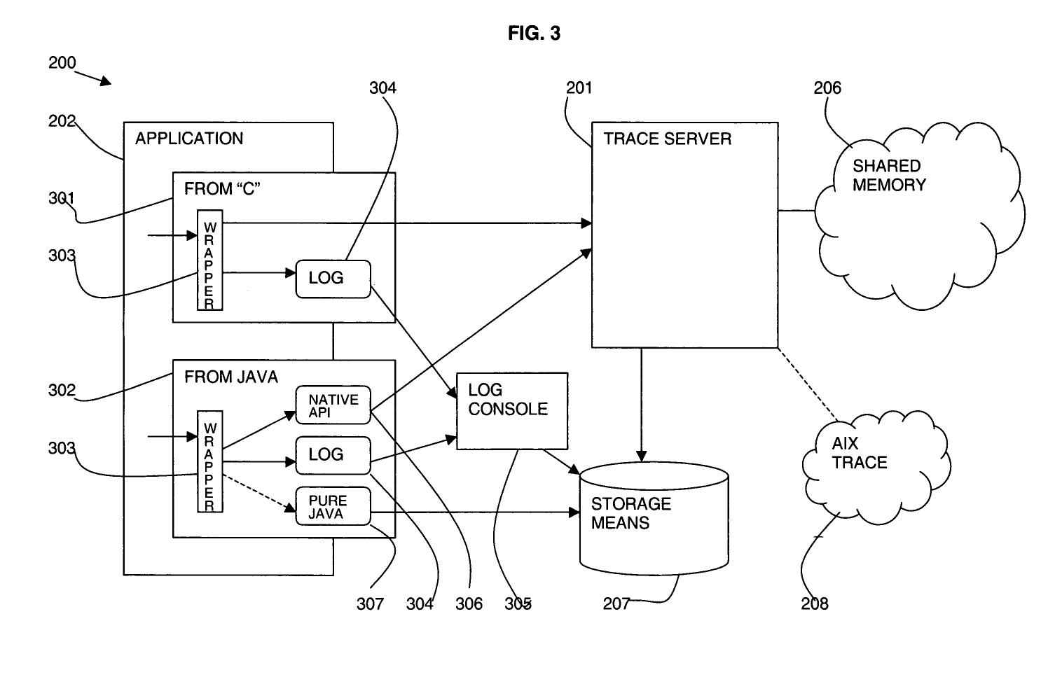

Referring to FIG. 3, the trace system 200 of FIG. 2 is shown with more detail. An application 203 presents tracing information. The tracing information may be from a native application, in this example, a C application 301 or from a non-native application, in this example, a Java application 302. The application trace layer of FIG. 2 is shown as a wrapper 303 which is a tracing API and provides an interface for applications 203 to call in with trace information.

The wrapper 303 sends trace information in the form of native code from a native application 301 to the trace server 201. The wrapper 303 sends native code 306 from a non-native application 302 to the trace server 201. In the example of a non-native application 302 in the form of a Java application, native code is C code that is called from Java code when running the Java application. C code is much faster than Java code and therefore, any substantial work is carried out by C code.

As a back-up, the pure non-native code 307, in this example the Java code, may also write to the storage means 207. As a subsidiary operation, the trace data may also be stored to an AIX operating system trace.

The wrapper 303 also generates a log 304 of log information from the application 202 which is processed by a log console 305 and stored to the storage means 207. The log 304 is generally for end users or administrative users and includes information such as errors and warnings. These log messages are of low density.

In the described trace system, trace data can be submitted from both native and non-native code from multiple applications. The trace system allows highly detailed tracing of internal functions in the code for debugging and program determination.

Each trace point in an application from which trace data is provided has a trace point ID, a component ID, and a bit pattern.

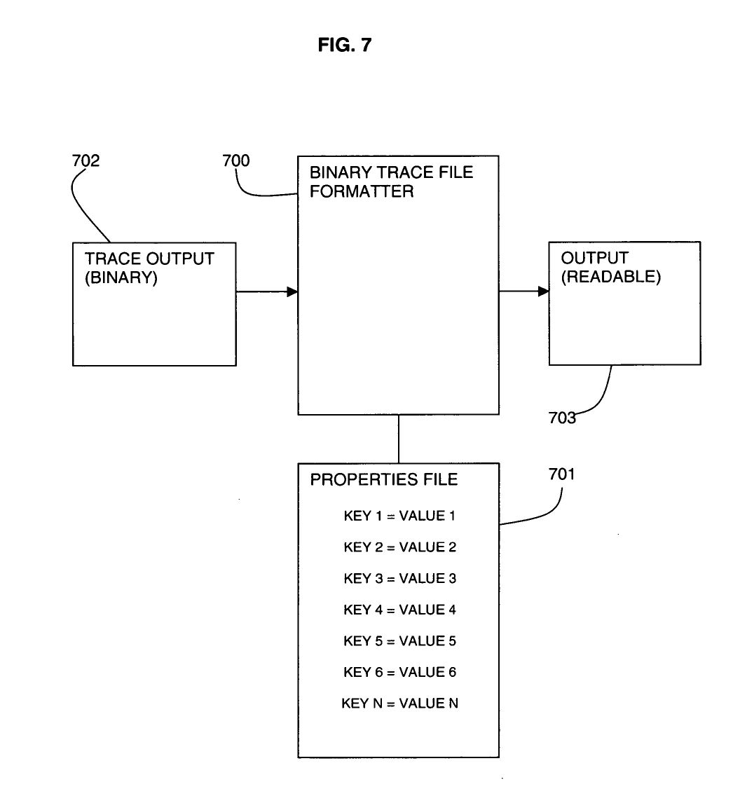

The trace point ID is a unique integer ID within the product. The trace point ID of each trace point enables an associated line of text that to be provided in a properties file that can provide any necessary description relating to the trace point. The application developer can insert the associated line of text during the developmental stage ensuring that the trace points are as informative as possible during a system trace. This aspect of the described system is described in detail in relation to FIG. 7.

The component ID identifies the component the trace message came from so that it can be filtered against the correct component.

The bit pattern stores the properties of the trace point, such that they may be filtered. Sample values would be:
Entry—when entering a new method
Exit—when returning from a method
Core—most important trace points—needed to understand what is happening.
Major—important trace points, for tracing data or code path that has important consequences.
Minor—trace points that describe (often in detail) the inner workings of methods, and values of data.
Error—trace points that record a behaviour deviation that is unexpected.
Warning—trace points that record a possibility of generating an error.
Data—trace points that record incidental data.
Loop—trace points that are issued from within a loop which could be very repetitive.
CPU_intensive—trace points with large amounts of data.

In the smallest case, each trace point has an associated 32 bytes, storing all the data of that trace point in binary format. This includes: timestamp (8 bytes), component ID (10 bits), bit pattern (22 bits), trace point ID (32 bits), thread ID, and other information.

The wrapper 303 determines if a trace point will be traced or not based on a current trace level and the bit pattern of the trace point.

Determination as to whether a specific trace point will be logged is based on a combination of factors. There is an overall product-wide tracing level (1 to 9), that has a graduated scale of how much tracing will be allowed to pass. This scale varies the combination of bits in the bit pattern from none set (1) to all set (9) that are permitted to pass.

Upon a trace call from an application, the bit pattern of the trace point must be checked in order to see whether the call is to be logged or not.

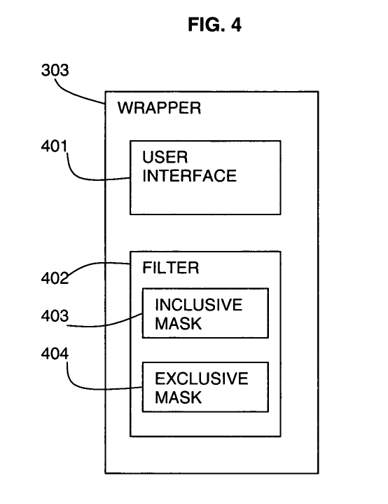

FIG. 4 shows the wrapper 303 with a user interface 401 and a filter 402 having a first checking means in the form of an inclusive bit mask 403 and a second checking means in the form of an exclusive bit mask 404. The advantage of having a filter with an inclusive bit mask 403 and an exclusive bit mask 404 is that the amount of tracing can be altered with ease. A low level of tracing can be left on at all times without overloading the tracing system. The level of tracing can be turned up at any time.

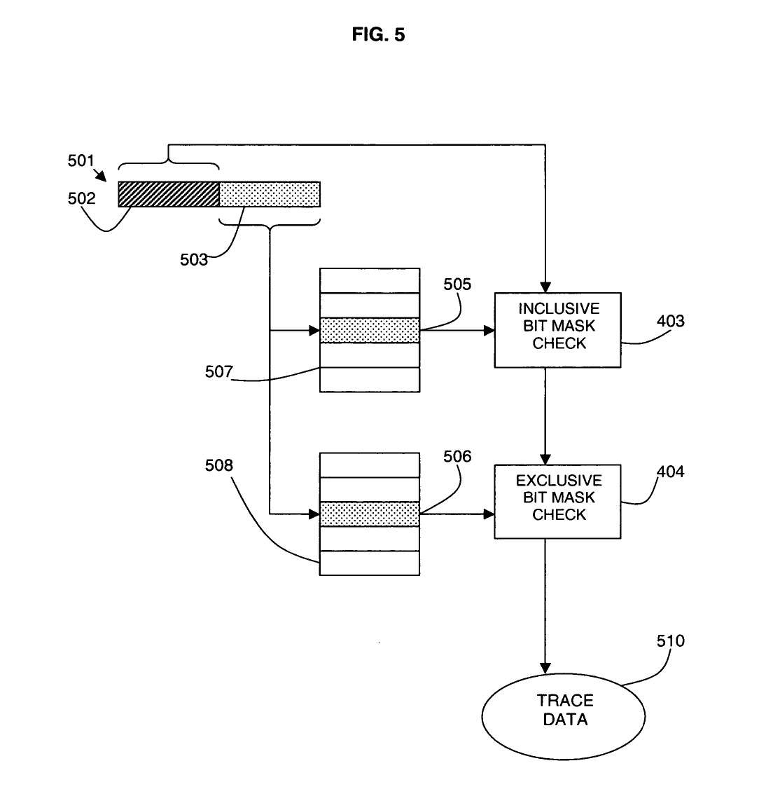

Referring to FIG. 5, the binary data for a trace point has a bit pattern 501 with a lower number of bits defining the component ID 503 and an upper number of bits defining a bit pattern for the category 502. As the component ID 503 refers to an element within an array (of which the component ID is the index value) then the inclusive and exclusive bit masks 505, 506 for that component need to be looked up in component bit mask lookup tables 507, 508.

An inclusive bit mask check 403 is carried out by comparing the inclusive bit mask 505 for the component ID 503 with the category 502. If this check is passed, an exclusive bit mask check 404 is carried out by comparing the exclusive bit mask 506 with the category 502. If this check is passed, the data is traced 510 for the trace point.

The first check of the inclusive bit mask 403 determines if any of the bits set in the trace point bit pattern 501 are permitted to pass. The second check of the exclusive bit mask 404 determines if any of the bits are set in the trace point bit pattern 501 are not permitted to pass.

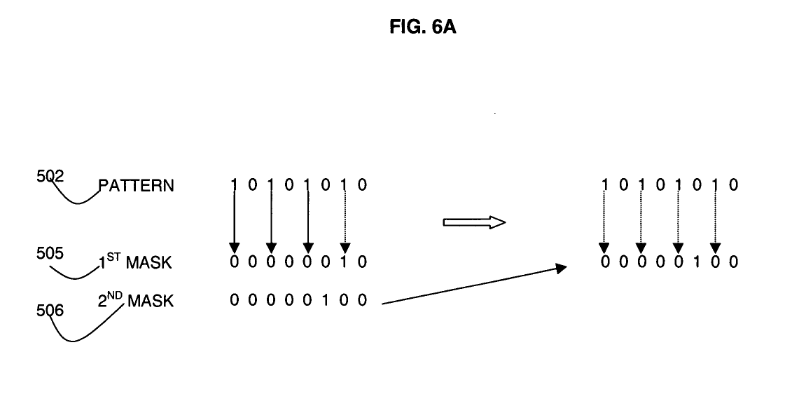

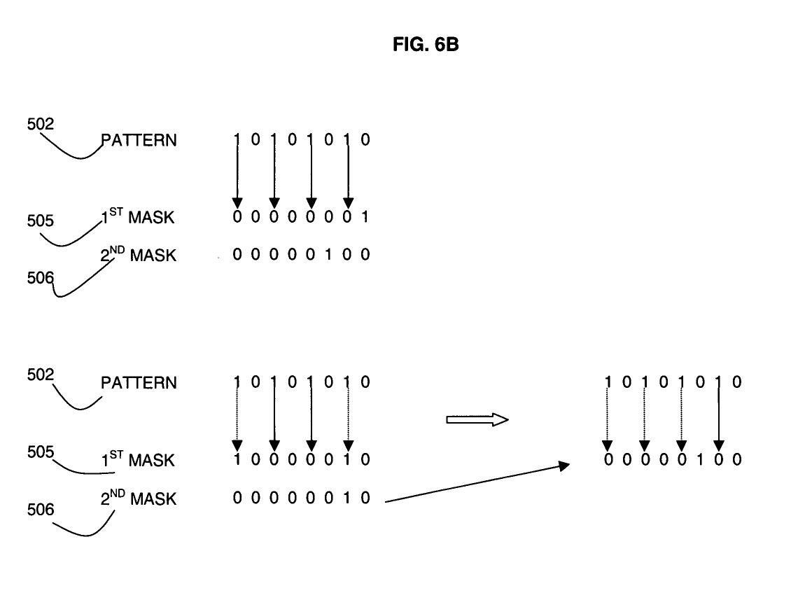

FIGS. 6A and 6B show a bit pattern 502 as compared to a first bit mask 505 for the inclusive bit mask check 403 and a second bit mask 506 for the exclusive bit mask check 404. In FIG. 6A, the first, inclusive bit mask check 403 is passed as one of the bits in the pattern 502 matches one of the bits in the bit mask 505. Therefore, the bit pattern 502 is passed to the second, exclusive bit mask check 404 which also passes as all of the “1”s in the bit pattern 502 match a “0” in the mask 506.

In FIG. 6B. the first example fails as none of the bits in the bit pattern 502 match the first, inclusive bit mask 505. The second example passes the first, inclusive bit mask check 403 as one of the bits in the pattern 502 matches one of the bits in the bit mask 505. However, it fails the second, exclusive bit mask check 404 as one of the “1”s in the bit pattern 502 correlates with a “1” in the bit mask 506.

This allows for flexible rules to say things like, for example, accept all CORE, MAJOR, DATA, ERROR, WARNING categories in the inclusive mask, but deny all LOOP and CPU_INTENSIVE in the exclusive mask. Additionally, all these checks can be performed on a per-component basis. For example, the overall trace level could be set to 9 (all trace on), but components 4, 5, and 6 could be set to deny all trace in the exclusive mask thereby turning them off.

Trace levels and individual inclusive and exclusive masks can be set dynamically for any component at runtime. The default tracing level is set to 2 which allows just CORE and ERROR which means a very small amount of trace is always running in the background for first failure data collection purposes. There is a programmatic and command line method of flushing the current trace data in memory to disk on demand. All string data that is traced is stored in Unicode where possible (the binary trace formatter default file output to UTF-8), other single-byte code pages can also be stored.

One aspect of the described system is the provision of human readable data relating to trace points. The trace point ID enables an associated message from a message catalogue to be read describing the trace point. Referring to FIG. 7, a binary trace file formatter 700 is provided which inserts an output at formatting time to provide a human readable form of the data. A message catalogue which may be in the form of a properties file 701 is automatically generated during the product build process based on custom comments in the source code.

The properties file 701 is a human readable text file, for example, as generated by java.util.Properties, with a simple “key=value” format on each line.

An example properties file 701 may contain key and values of the following form:
1000012=this is the description for a trace call
1000013=this is the next one, with some data to be inserted by the formatter here: {0}
1000001=and the order of the messages doesn't matter
6=neither does the length of the number.
2000003=this is some output: {0} and some more: {1}

The binary file formatter 700 is an application that takes the trace output 702 of a trace point which is a binary file and thus not human readable. The binary file formatter 700 reads the trace output 702, formats it to make it humanly readable and, inserts the text messages from the properties file 701 relating to the trace point. The binary file formatter 700 outputs a readable output 703. The binary file formatter 700 is run on the trace file after the system has produced it, only if a user requests to read it. This saves processing as it is not run unless a user wishes to read it.

### EXAMPLE

The following trace may be traced out to disk:
Time: <July 27^{th}, 13:54.123456 in milliseconds since 1970>
Bit pattern: <Core>
<other data>
Component: <My Component ID>
Data: data1, data2

The formatter 700 would read this and write it out as the following (using the properties file 701 above):
27-07-2004: 13:54:25-123456 <other data here> my Component: this is some output: data1 and some more: data2

There is a defined format for the comment field with keywords being used. The application developer inserts descriptive text in the source code at a trace point. In an overnight build process, an application tool is run which reads the source code, extracts the trace line definition and puts it in a properties file which is accessed by the unique integer ID of the trace point when required to be read.

When a trace point is written the unique integer ID is inserted in the source code. The application tool looks after combining the trace point to the descriptive text definition using the unique integer ID. The tool ensures that the descriptive text definition does not get out of synch with the source code.

When the code is written, and a trace point is identified, the code may be as follows: (The number 1000012 is the unique ID for the trace point.)

| Trace( [Component ID] , [bit pattern], 1000012, [data]); | |
|---|---|
| /*# | |
| * <TracepointID> 1000012 | |
| * <String> | this is the description for a |
| trace call | |
| */ | |

At build time the tool goes through all the trace points and finds the sections beginning with /*#. Then it pulls out the Tracepoint ID number and the string and adds them to the properties file with a line like this:
1000012=this is the description for a trace call

The original data is left unmodified and stored with sufficient attributes to allow the offline binary formatter to reconstruct the data. As little work as possible is done at runtime for maximum performance. The text in the properties files gathered at build time complies with the java.text (ICU) standard and can be internationalised, if required.

The described trace system and method have the advantage that the system runs in the background with a minimal overhead. The system has first failure data collection. A single trace file is provided for the whole computer system under trace from native and non-native applications. There is also in-built support for Call IDs. The system uses native code for performance with pure non-native, e.g. Java backup. The system is also able to differentiate logging and tracing.

The described embodiment has the advantages of a very fast filtering system which provides a good compromise between high speed and high control of the filter.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. A method for filtering components to be traced in computer applications comprising:
providing a trace point in a computer application with a bit pattern;
carrying out an inclusive test by comparing the bit pattern to an inclusive bit mask, accepting the bit pattern if a bit of the bit pattern matches the bit mask;
carrying out an exclusive test by comparing the bit pattern to an exclusive bit mask, accepting the bit pattern if none of the bits of the bit pattern matches the bit mask; and
tracing a trace point which is accepted by both the inclusive test and the exclusive test.

2. A method as claimed in claim 1, wherein a bit pattern for a trace point represents a category of the trace point.

3. A method as claimed in claim 1, wherein the bit pattern for a trace point represents a component in the computer application.

4. A method as claimed in claim 1, wherein the inclusive and the exclusive bit masks determine the level of tracing.

5. A method as claimed in claim 1, wherein the trace points are provided in native and non-native applications.

6. A method for tracing components in computer applications comprising:
providing text commentary in source code associated with trace points;
storing the text commentary in a catalogue at compilation of the source code; and
retrieving the text commentary when a trace point is traced.

7. A method as claimed in claim 6, wherein each trace point has a unique identifier and the text commentary is referenced by the unique identifier.

8. A method as claimed in claim 6, wherein the method includes retrieving the text commentary during formatting of the trace point data.

9. A method as claimed in claim 6, wherein the trace points are provided in native and non-native applications.

10. A method for tracing components in computer applications comprising:
providing each trace point with a unique identifier and a bit pattern;
filtering the trace points to be traced by comparing the bit pattern to a filter mask; and
formatting the data from the trace point including retrieving text commentary referenced by the unique identifier.

11. A method as claimed in claim 10, wherein the filtering includes:
carrying out an inclusive test by comparing the bit pattern to an inclusive bit mask, accepting the bit pattern if a bit of the bit pattern matches the bit mask;
carrying out an exclusive test by comparing the bit pattern to an exclusive bit mask, accepting the bit pattern if none of the bits of the bit pattern matches the bit mask; and
tracing a trace point which is accepted by both the inclusive test and the exclusive test.

12. A method as claimed in claim 10, wherein a bit pattern for a trace point represents a category of the trace point.

13. A method as claimed in claim 10, wherein the bit pattern for a trace point represents a component in the computer application.

14. A method as claimed in claim 10, wherein the inclusive and the exclusive bit masks determine the level of tracing.

15. A method as claimed in claim 10, wherein the trace points are provided in native and non-native applications.

16. A system for tracing components in computer applications comprising:
a trace server for logging data from one or more applications;
filtering means for filtering data to be logged from trace points in the applications including:
means for carrying out an inclusive test to determine if a trace point is to be logged; and
means for carrying out an exclusive test to determine if a trace point is not to be logged.

17. A system as claimed in claim 16, wherein the inclusive and exclusive tests set the trace level.

18. A system as claimed in claim 16, wherein each trace point has a bit pattern, the means for carrying out the inclusive test compares the bit pattern to an inclusive bit mask and accepts the bit pattern if a bit of the bit pattern matches the bit mask, and the means for carrying out an exclusive test compares the bit pattern to an exclusive bit mask and accepts the bit pattern if none of the bits of the bit pattern matches the bit mask;
the filtering means forwards data to the trace server from trace points which are accepted by both the inclusive test and the exclusive test.

19. A system as claimed in claim 18, wherein the bit pattern of a trace point represents the category of the trace point.

20. A system as claimed in claim 18, wherein the bit pattern for a trace point represents a component in the computer application.

21. A system as claimed in claim 16, wherein the system includes shared memory for storing binary formatted trace data; and storage means to which the trace data is written in blocks form the shared memory.

22. A system as claimed in claim 16, wherein the trace points are provided in native and non-native applications.

23. A system for tracing components in computer applications comprising:
a formatter for formatting the trace data for a trace point;
a catalogue storing the text commentary associated with a trace point; and
the formatter including means for retrieving the text commentary for a trace point.

24. A system as claimed in claim 23, wherein each trace point has a unique identifier and the catalogue identifies the text commentary by the unique identifier.

25. A system for tracing components in computer applications comprising:
means for providing trace points with a unique identifier and a bit pattern;
filtering means for filtering the trace points to be traced by comparing the bit pattern to a filter mask;
formatting means for formatting the data from the trace point including retrieving text commentary referenced by the unique identifier.

26. A system as claimed in claim 25, wherein the filtering means compares the bit pattern to an inclusive mask and an exclusive mask to set the trace level.

27. A system as claimed in claim 26, wherein the filtering means includes means for carrying out an inclusive test comparing the bit pattern to an inclusive bit mask and accepting the bit pattern if a bit of the bit pattern matches the bit mask, and means for carrying out an exclusive test comparing the bit pattern to an exclusive bit mask and accepting the bit pattern if none of the bits of the bit pattern matches the bit mask;
the filtering means forwards data to a trace server from trace points which are accepted by both the inclusive test and the exclusive test.

28. A system as claimed in claim 25, wherein the bit pattern of a trace point represents the category of the trace point.

29. A system as claimed in claim 25, wherein the bit pattern for a trace point represents a component in the computer application.

30. A computer program product stored on a computer readable storage medium, comprising computer readable program code means for performing the steps of:
providing a trace point in a computer application with a bit pattern;
carrying out an inclusive test by comparing the bit pattern to an inclusive bit mask, accepting the bit pattern if a bit of the bit pattern matches the bit mask;
carrying out an exclusive test by comparing the bit pattern to an exclusive bit mask, accepting the bit pattern if none of the bits of the bit pattern matches the bit mask; and
tracing a trace point which is accepted by both the inclusive test and the exclusive test.

31. A computer program product stored on a computer readable storage medium, comprising computer readable program code means for performing the steps of:
providing text commentary in source code associated with trace points;
storing the text commentary in a catalogue at compilation of the source code; and
retrieving the text commentary when a trace point is traced.

32. A computer program product stored on a computer readable storage medium, comprising computer readable program code means for performing the steps of:
providing text commentary in source code associated with trace points;
storing the text commentary in a catalogue at compilation of the source code; and
retrieving the text commentary when a trace point is traced.
